(19) United States
(12) Patent Application Publication
(10) Pub. No.: US 2026/0023050 A1
(43) Pub. Date: Jan. 22, 2026

(54) METHODS FOR ANALYZING LIPID NANOPARTICLES AND USES THEREOF

(71) Applicant: Waters Technologies Corporation, Milford, MA (US)

(72) Inventors: Lavelay Kizekai, Coventry, RI (US); Abraham Finny, Marlborough, MA (US); Balasubrahmanyam Addepalli, Bellingham, MA (US); Matthew A Lauber, North Smithfield, RI (US)

(73) Assignee: Waters Technologies Corporation, Milford, MA (US)

(21) Appl. No.: 19/273,535

(22) Filed: Jul. 18, 2025

Related U.S. Application Data
(60) Provisional application No. 63/674,056, filed on Jul. 22, 2024.

(51) Int. Cl. G01N 30/14; G01N 30/06; G01N 30/60; G01N 30/74

(52) U.S. Cl. CPC G01N 30/14; G01N 30/6052; G01N 30/74; G01N 2030/062

(57) ABSTRACT

The present disclosure is directed to methods of performing size-exclusion chromatography for the separation and characterization of lipid nanoparticles and compositions or samples comprising the same. The methods provided herein afford improved separation and characterization of lipid nanoparticles, including aggregate formation.

### RELATED APPLICATIONS

This application claims priority and benefit to U.S. Provisional Patent Application No. 63/674,056, filed on Jul. 22, 2024, the content of which is incorporated herein by reference in its entirety.

### FIELD OF THE INVENTION

The present technology is directed to methods for analyzing lipid nanoparticles. More particularly, the present technology is directed to size exclusion chromatography methods for separating and detecting lipid nanoparticles.

### BACKGROUND

Recent advances in nucleic acid-based therapies have resulted in an increased need for delivery mechanisms, including lipid nanoparticles. Lipid nanoparticles are typically made of four lipids, including ionizable/cationic lipids, phospholipids, cholesterol, and pegylated lipids. Due to the composition of the lipid nanoparticles, and the negatively charged nucleic acids which are encapsulated therein, lipid nanoparticles have the capacity to self-associate and aggregate. Thus, the ability to characterize the absolute physical properties, including the extent of aggregation, is critical for determining lipid nanoparticle potency, purity, and safety. Current methods for analyzing lipid nanoparticles can fail to detect aggregates or other impurities. Accordingly, a need in the art exists for methods that accurately characterize lipid nanoparticles and compositions thereof.

### SUMMARY OF THE INVENTION

In general, the present technology is directed to methods of separating and characterizing lipid nanoparticles (LNP) with size-exclusion chromatography. In particular, the present technology provides a mobile phase composition comprising a low-ionic strength buffer, arginine, and sucrose, which increases LNP recovery and aggregate detection.

Accordingly, in one aspect, provided herein is a method for separating a sample that comprises a lipid nanoparticle, the method comprising a) injecting onto a size-exclusion chromatography (SEC) column the sample comprising the lipid nanoparticle, b) flowing the sample through the SEC column using a mobile phase comprising a low-ionic strength buffer, sucrose, and arginine, and c) detecting the lipid nanoparticle eluted from the column with a detector.

In some embodiments, the low-ionic strength buffer comprises a salt selected from the group consisting of: potassium phosphate; monopotassium phosphate; dipotassium phosphate; sodium phosphate; monosodium phosphate; disodium phosphate; sodium chloride; potassium chloride; calcium chloride; magnesium chloride; potassium sulfate; sodium sulfate; and combinations thereof. In some embodiments, the low-ionic strength buffer has a total ionic strength of between 0.1 to 30 mM. In some embodiments, the low-ionic strength buffer has a total ionic strength of between 0.6 to 5 mM.

In some embodiments, the arginine is at a concentration of between 0.1 to 4 mM. In some embodiments, the arginine is at a concentration of about 3 mM. In some embodiments, the low-ionic strength buffer includes 0.6 to 5 mM sodium phosphate or 0.6 to 5 mM potassium phosphate. In some embodiments, the sucrose is at a concentration of between 20-200 mM.

In some embodiments, the mobile phase further includes a non-ionic detergent. In some embodiments, the non-ionic detergent is polysorbate 80 or polysorbate 20. In some embodiments, the non-ionic detergent is at a concentration of between 0.006%-0.025% (w/v).

In some embodiments, the SEC column includes hydroxy- or methoxy-terminated porous particles having a particle size of between 1 μm to 10 μm. In some embodiments, the particle size is about 3 μm. In some embodiments, the porous particles have an average pore diameter of between 1000 Å to 5000 Å. In some embodiments, the porous particles have an average pore diameter of about 2000 Å.

In some embodiments, the detector is an ultraviolet detector. In some embodiments, the ultraviolet detector measures at between 210 to 300 nm, or between 260 nm to 280 nm.

In one aspect, the method further comprises an alkylsilyl coating on an interior surface of the SEC column. In some embodiments, the alkylsilyl coating includes a vapor deposited product of bis(trichlorosilyl)ethane or bis(trimethoxysilyl)ethane.

### BRIEF DESCRIPTION OF THE DRAWINGS

The technology will be more fully understood from the following detailed description taken in conjunction with the accompanying drawings.

FIG. 1A provides a chromatogram of an LNP sample separated using a mobile phase having different total ionic strengths.

FIG. 1B provides an expanded view of the boxed area of the chromatogram provided in FIG. 1A.

FIG. 2A provides a chromatogram of an LNP sample (LNP Sample #1) separated with or without arginine.

FIG. 2B provides an expanded view of the boxed area of the chromatogram provided in FIG. 2A.

FIG. 2C provides a chromatogram of an LNP sample (LNP Sample #2) separated with or without arginine.

FIG. 2D provides an expanded view of the boxed area of the chromatogram provided in FIG. 2C.

FIG. 3A provides a chromatogram of an LNP sample separated using a mobile phase having a concentration of 0 mM sucrose.

FIG. 3B provides a chromatogram of an LNP sample separated using a mobile phase having a concentration of 30 mM sucrose.

FIG. 3C provides a chromatogram of an LNP sample separated using a mobile phase having a concentration of about 50 mM sucrose.

### DETAILED DESCRIPTION

Disclosed herein are size exclusion chromatography (SEC) methods for the separation of lipid nanoparticles, samples comprising lipid nanoparticles, and compositions comprising the same.

In order that the technology may be more readily understood, certain terms are first defined. In addition, it should be noted that whenever a value or range of values of a parameter are recited, it is intended that values and ranges intermediate to the recited values are also part of this disclosure. The word “about” if not otherwise defined means±5%. It is also to be noted that as used herein and in the claims, the singular forms “a” and “the” include plural references unless the context clearly indicates otherwise.

### Definitions

The present technology utilizes mobile phases comprising a low-ionic strength buffer. As used herein, the term “low-ionic strength buffer” refers to a buffer having a total ionic strength of less than 50 mM or more preferably 30 mM. Ionic strength of a buffer is a measure of the concentration of the ionic charge in the buffer. Ionic strength can be determined using methods readily known in the art. Ionic strength can be represented by the formula:

$$I = \frac{1}{2} {\sum }_{1}^{n} {C}_{i} {Z}_{i}^{2}$$

wherein C is the concentration in molar units (mol/L) and Z is the charge of each ion. As such, ionic strength can be represented in units of moles per liter (mol/L), i.e., molarity (M). As used herein, the term “total ionic strength” refers to the sum of the concentration of all ionic species present in a buffer.

As used herein, the term “lipid nanoparticle” refers to a nanoparticle having a diameter of less than 1000 nm. Lipid nanoparticles typically comprise a combination of one or more cationic or ionizable lipids, phospholipids, cholesterol, and pegylated lipids. Lipid nanoparticles may further comprise a nucleic acid, such as an mRNA, encapsulated within the interior of the lipid nanoparticle. Lipid nanoparticles are further described in, for example, U.S. Pat. No. 11,141,378, U.S. Publication No. 2021/0113466, U.S. Publication No. 2021/0346306, U.S. Pat. No. 8,420,123, incorporated herein by reference as it pertains to lipid nanoparticles and compositions thereof.

### Mobile Phase Compositions

Provided herein are mobile phase compositions suitable for use with size-exclusion chromatography methods for separating lipid nanoparticles and samples or compositions comprising the same.

In one aspect, the mobile phase compositions provided herein comprise a low-ionic strength buffer, arginine, and sucrose.

In one aspect, the low-ionic strength buffers of the present technology have a total ionic strength that does not exceed about 50 mM. That is, the total ionic strength of the buffer is between 0.1 to 50 mM. In some embodiments, the low-ionic strength buffer has a total ionic strength of between about 0.1 to 50 mM, 0.1 to 45 mM, 0.1 to 40 mM, 0.1 to 35 mM, 0.1 to 30 mM, 0.1 to 25 mM, 0.1 to 20 mM, 0.1 to 15 mM, 0.1 to 10 mM, or 0.1 to 5 mM. In some embodiments, the total ionic strength does not exceed about 30 mM. In some embodiments, the total ionic strength of the buffer is between 0.1 to 30 mM. In some embodiments, the low-ionic strength buffer has a total ionic strength of between 0.6 to 5 mM.

The low-ionic strength buffer may comprise one or more suitable salts. For example, but not by way of limitation, the low-ionic strength buffer may comprise a salt selected from the group consisting of: potassium phosphate (including monopotassium phosphate and/or dipotassium phosphate); sodium phosphate (including monosodium phosphate and/or disodium phosphate); sodium chloride; potassium chloride; calcium chloride; magnesium chloride; potassium sulfate; sodium sulfate; and combinations thereof.

In some embodiments, the low-ionic strength buffer comprises potassium phosphate and/or sodium phosphate. For example, the low-ionic strength buffer may comprise 0.6 to 5 mM potassium phosphate and/or 0.6 to 5 mM sodium phosphate.

In other embodiments, the low-ionic strength buffer comprises a reduced concentration of phosphate buffered saline (PBS), such as between 0.1 to 0.2×PBS. For example, in said embodiments, the low-ionic strength buffer comprises about 27.4 mM sodium chloride, about 0.54 mM potassium chloride, and about 2.03 mM phosphate. Alternatively, the low-ionic strength buffer comprises about 27.4 mM sodium chloride, about 0.54 mM potassium chloride, about 0.3 mM monopotassium phosphate, and about 1.62 mM monosodium phosphate.

In yet other embodiments, the low-ionic strength comprises a reduced concentration of Dulbecco's phosphate buffered saline (DPBS), such as between 0.1 to 0.2×DPBS. For example, in said embodiments, the low-ionic strength buffer comprises about 0.10 mM magnesium chloride, about 27.4 mM sodium chloride, about 0.18 mM calcium chloride, about 0.54 mM potassium chloride, and 2.03 mM phosphate. Alternatively, the low-ionic strength buffer comprises about 0.10 mM magnesium chloride, about 27.4 mM sodium chloride, about 0.18 mM calcium chloride, about 0.54 mM potassium chloride, about 0.3 mM monopotassium phosphate, and about 1.62 mM monosodium phosphate.

The mobile phase compositions of the present technology comprise arginine. Without wishing to be bound by any particular theory, it is believed that the addition of low concentrations of arginine in the mobile phase affords enhanced separation of lipid nanoparticles when separated by size-exclusion chromatography. Accordingly, in some embodiments, the mobile phase comprises between 0.1 to 4 mM arginine. In some embodiments, the mobile phase comprises between 0.1 to 0.5 mM, 0.5 to 1 mM, 1 mM to 1.5 mM, 1.5 to 2 mM, 2 to 2.5 mM, 2.5 to 3 mM, 3 to 3.5 mM, or 3.5 to 4 mM arginine. In some embodiments, the mobile phase comprises about 3 mM arginine. In some embodiments, the mobile phase comprises about 1.43 mM arginine.

The mobile phase compositions of the present technology comprise sucrose. In some embodiments, the mobile phase comprises between 20 to 200 mM sucrose. In some embodiments, the mobile phase comprises between 20 to 180 mM, 20 to 160 mM, 20 to 140 mM, 20 to 120 mM, 20 to 100 mM, 20 to 80 mM, 20 to 60 mM, 20 to 40 mM, 40 to 200 mM, 40 to 180 mM, 40 to 160 mM, 40 to 140 mM, 40 to 120 mM, 40 to 100 mM, 40 to 80 mM, 40 to 60 mM, 60 to 200 mM, 60 to 180 mM, 60 to 160 mM, 60 to 140 mM, 60 to 120 mM, 60 to 100 mM, 60 to 80 mM, 80 to 200 mM, 80 to 180 mM, 80 to 160 mM, 80 to 140 mM, 80 to 120 mM, 80 to 100 mM, 100 to 200 mM, 100 to 180 mM, 100 to 160 mM, 100 to 140 mM, 100 to 120 mM, 120 to 200 mM, 120 to 180 mM, 120 to 160 mM, 120 to 140 mM, 140 mM to 200 mM, 140 to 180 mM, 140 to 160 mM, 160 to 200 mM, 160 to 180 mM, or 180 to 200 mM sucrose.

In some embodiments, the mobile phase comprises an osmoprotectant small saccharide additive, such as, for example, sucrose as described above. As used herein, the term “small saccharide” refers to a mono-, di-, or tri-saccharide molecule. Without wishing to be bound by any particular theory, it is believed that addition of the small saccharide additive provides osmoprotection, thereby stabilizing lipid nanoparticles present in a sample. Accordingly, in some embodiments, the mobile phase compositions of the present technology may have an osmotic pressure of between about 0.5 to 10 standard atmospheres (atm), or more preferably 1 to 5 atm. Methods of determining osmotic pressure of a solution are known in the art.

Small saccharides may include, but are not limited to, sucrose, trehalose, glucose, maltose, lactose, fructose, or substituted small saccharides, such as chlorinated sucralose. In some embodiments, the small saccharide is a non-nutritive or low caloric content molecule thereby minimizing potential microbial growth in the mobile phase.

Accordingly, in some embodiments, the mobile phase compositions of the present technology may comprise a small saccharide. In some embodiments, the small saccharide of the mobile phase may comprise sucrose, trehalose, glucose, maltose, lactose, fructose, or combinations thereof.

The mobile phase compositions of the present technology may further comprise a non-ionic detergent. In some embodiments, the non-ionic detergent is polysorbate 80 or polysorbate 20. In some embodiments, the non-ionic detergent is at a concentration of between 0.006%-0.025% (w/v). In some embodiments, the non-ionic detergent is polysorbate 20 at a concentration of between 0.006%-0.025% (w/v). In some embodiments, the non-ionic detergent is polysorbate 80 at a concentration of between 0.006%-0.025% (w/v). In some embodiments, the non-ionic detergent is at a concentration of between 0.006% to 0.01% (w/v), 0.01% to 0.015% (w/v), 0.015% to 0.02% (w/v), or 0.02% to 0.025% (w/v).

The mobile phase compositions may comprise any combination of the above components, namely the low-ionic strength buffer, the arginine, and the sucrose. In some embodiments, the mobile phase compositions may comprise any combination of the above components, further comprising a non-ionic detergent.

In some embodiments, the mobile phase composition comprises a low-ionic strength buffer having a total ionic strength of between 0.1 to 30 mM, arginine at a concentration of between 0.1 to 4 mM, and sucrose at a concentration of between 20 to 200 mM. In some embodiments, the mobile phase composition comprises a low-ionic strength buffer having a total ionic strength of between 0.1 to 30 mM, arginine at a concentration of between 0.1 to 4 mM, sucrose at a concentration of between 20 to 200 mM, and a non-ionic surfactant at a concentration of between 0.006%-0.025%. In some embodiments, the mobile phase composition comprises a low-ionic strength buffer having a total ionic strength of between 0.1 to 5 mM, arginine at a concentration of between 0.1 to 4 mM, sucrose at a concentration of between 20 to 200 mM, and a non-ionic surfactant at a concentration of between 0.006%-0.025%. In some embodiments, the mobile phase composition comprises a low-ionic strength buffer having a total ionic strength of between 0.1 to 5 mM, arginine at a concentration of about 3 mM, and sucrose at a concentration of between 50 to 150 mM. In some embodiments, the mobile phase composition comprises a low-ionic strength buffer having a total ionic strength of between 0.1 to 5 mM, arginine at a concentration of about 3 mM, sucrose at a concentration of between 50 to 150 mM, and a non-ionic surfactant at a concentration of between 0.006%-0.025%. In some embodiments, the low-ionic strength buffer comprises a sodium phosphate or potassium phosphate buffer. In some embodiments, the non-ionic surfactant is polysorbate 80 or polysorbate 20.

The mobile phase buffer may be at a pH suitable for use with size exclusion chromatography and the total ionic strength of the buffer. For example, the pH of the low-ionic strength buffer may be between about 6.5 to 7.5. In some embodiments, the pH of the low-ionic strength buffer is about 7.0. In some embodiments, the pH of the low-ionic strength buffer is about 7.2.

In one aspect, the mobile phase consists essentially of a low-ionic strength buffer, arginine, and sucrose. In said embodiments, the mobile phase consists essentially of a low-ionic strength buffer, arginine at a concentration of between 0.1 mM to 4 mM, and sucrose. In some embodiments, the mobile phase consists essentially of a low-ionic strength buffer, arginine, and a small saccharide.

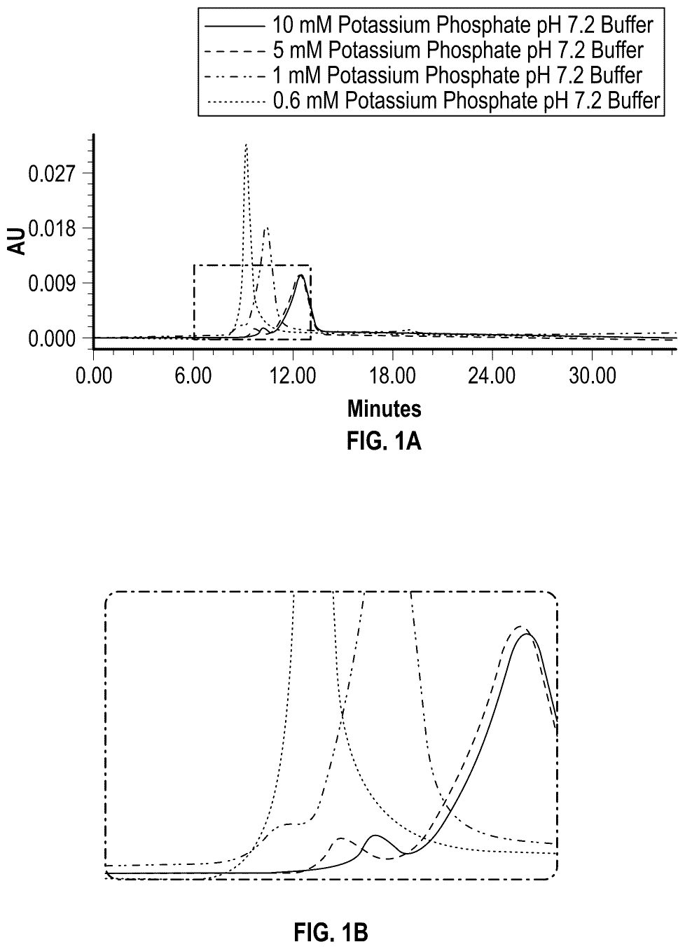

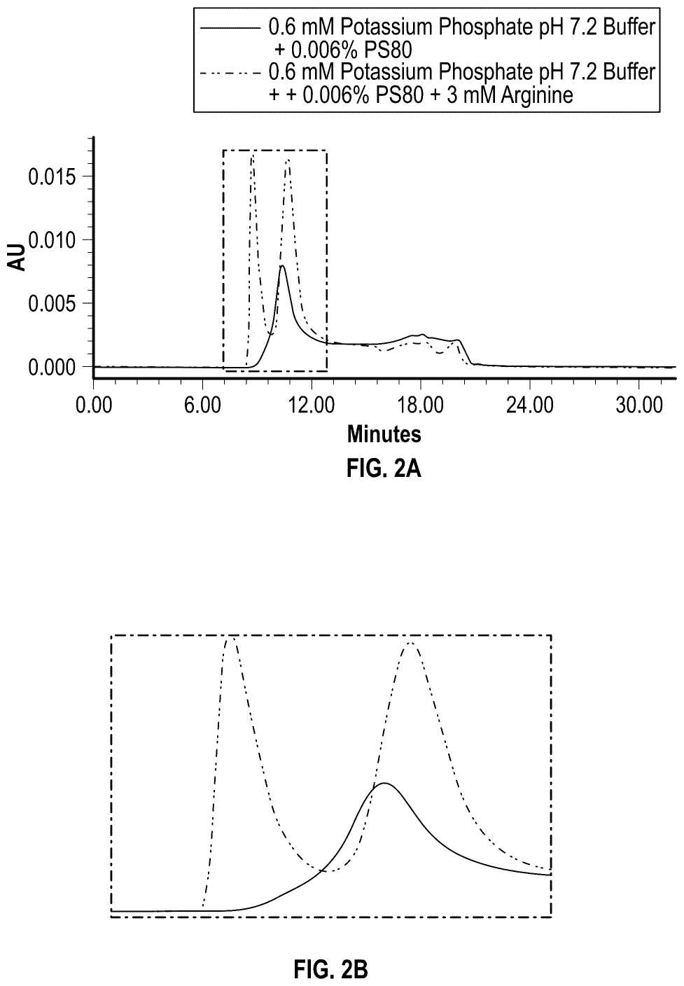

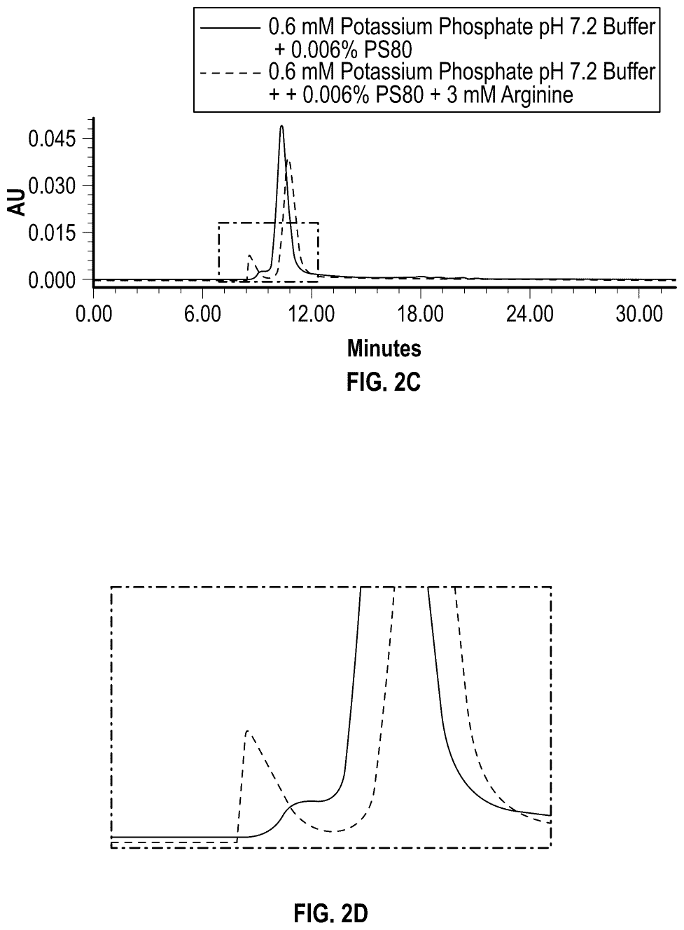

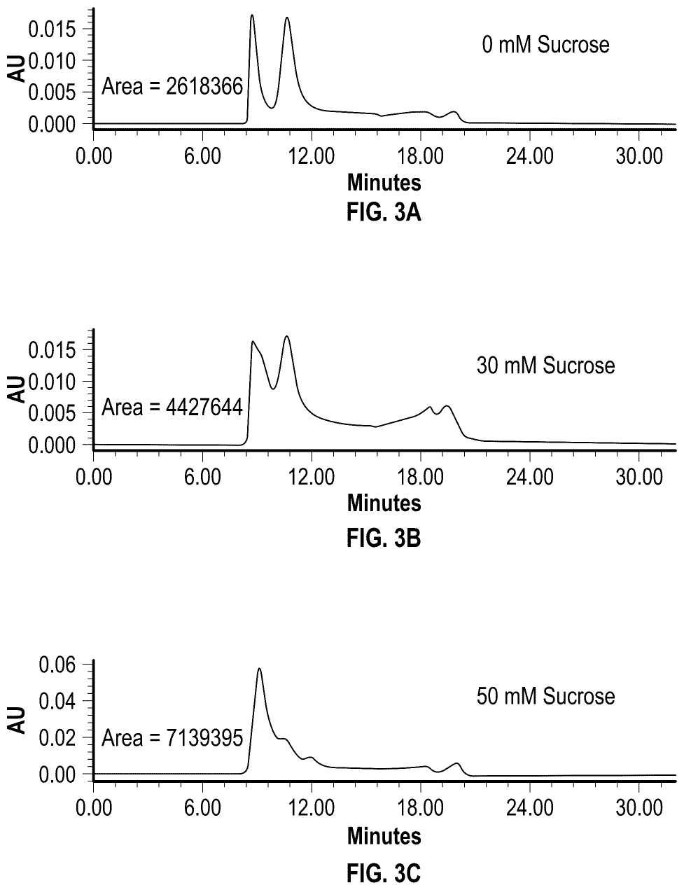

Example 1 demonstrates the efficiency of separation of LNP samples afforded by the mobile phase compositions provided herein. FIG. 1A and FIG. 1B show the improved signal afforded by the low-ionic strength buffers described herein. FIG. 2A, FIG. 2B, FIG. 2C and FIG. 2D demonstrate the improved resolution, including the resolution of LNP aggregates, afforded by the addition of arginine. FIG. 3A-FIG. 3C demonstrate the improved signal afforded by the addition of sucrose.

### Chromatography Systems and Materials

The mobile phase compositions described herein are suitable for use with chromatography systems, particular chromatography systems equipped with size exclusion chromatography (SEC) columns.

SEC columns suitable for use with the present technology comprise porous particles, in particular, hydroxy-terminated and/or methoxy-terminated particles. The porous particles suitable for use with the present technology may have an average particle size of between 1 μm to 10 μm. In some embodiments, the average particle size is 3 μm. The porous particles suitable for use with the present technology have an average pore diameter of between 1000 Å to 5000 Å. In some embodiments, the average pore diameter is between 1000 to 2000 Å, 2000 to 3000 Å, 3000 to 4000 Å, or 4000 to 5000 Å. In some embodiments, the average pore diameter is about 2000 Å.

Particles suitable for use with the present technology may comprise inorganic material (i.e., silica), organic material, or inorganic/organic hybrid material and may further be methoxy- and/or hydroxy-terminated. In some embodiments, the particles comprise a bonding phase formed by a dipodal hybrid silane comprising two indirectly linked silica atoms and a functionalized silane.

For example, but not by way of limitation, the particle may comprise on a surface of the particle a dipodal hybrid silane of the formula:

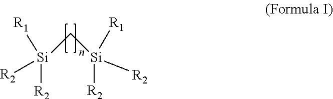

wherein:
R₁ is each independently chlorine, methoxyl, or ethoxyl;
R₂ is each independently alkyl, methoxyl, ethoxyl, or chlorine; and
n and m are each independently 1-4; and
   a functionalized silane of the formula:

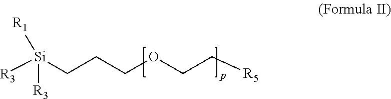

wherein:
R₁ is each independently chlorine, methoxyl, or ethoxyl;
R₃ is each independently alkyl, methoxyl, ethoxyl, or chlorine;
R₅ is hydroxyl or methoxyl; and
p is an integer from 1-12.

In some embodiments, R₅ is hydroxyl, and n is 2.

In some embodiments, an alkylsilyl coating or other high-performance surface (HPS) is provided to limit or reduce non-specific binding of a sample with the walls or interior surfaces of the column body. Without wishing to be bound by any particular theory, it is believed that an alkylsilyl coating covering metal surfaces prevents or otherwise minimizes contact between fluids passing through the column. The alkylsilyl coating can be applied to the interior surfaces defining what is known as a wetted path of the column. A metal wetted path includes all surfaces formed from metal that are exposed to fluids during operation of the chromatographic column. The metal wetted path includes not only the column body walls but also metal frits disposed within the column. The coating may be applied not only to the wall of the column body but also the frits.

In general, the alkylsilyl coating is applied through a vapor deposition technique. Vaporized precursors are charged into a reactor in which the part to be coated is located. These vaporized precursors react on the surfaces of the part to be coated to form a first layer of deposited material. The vapor deposition can be applied in a stepwise function to apply a number of layers of deposited material to the surfaces to grow a thickness of the coating and/or to apply layers of different materials (e.g., alternating between a first and a second material) to form the coating.

In some embodiments, the alkylsilyl coating is applied to other portions of the chromatography system. For example, the alkylsilyl coating can be applied to metal components residing upstream and downstream of the column. Specifically, the alkylsilyl coating can be applied to an injector of the chromatography system and to post column tubing and connectors (e.g., tubing and connectors leading from the column to downstream components such as detectors).

In some embodiments, the SEC column comprises an alkylsilyl coating on an interior surface of the SEC column. In some embodiments, the alkylsilyl coating comprises a vapor deposited product of bis(trichlorosilyl)ethane or bis(trimethoxysilyl)ethane.

The SEC column may further be connected in fluidic series with one or more detectors. Detectors suitable for use with the methods described herein include ultraviolet (UV) detectors, multi-angle light scattering (MALS) detectors, and/or fluorescence detectors.

In some embodiments, the detector is an ultraviolet detector. In embodiments wherein the detector is an ultraviolet detector, the ultraviolet detector detects at a wavelength of between 210 to 300 nm. In some embodiments, the ultraviolet detector detects at a wavelength of between 260 to 280 nm.

Methods of performing size exclusion chromatography to separate and characterize lipid nanoparticles (LNPs) are provided herein. In one aspect, the method comprises:
a) injecting onto a size-exclusion chromatography (SEC) column the sample comprising the lipid nanoparticle;
b) flowing the sample through the SEC column using a mobile phase comprising a low-ionic strength buffer, sucrose, and arginine; and
c) detecting the lipid nanoparticle eluted from the column with a detector.

In another aspect, the method comprises:
a) injecting onto a size-exclusion chromatography (SEC) column the sample comprising the lipid nanoparticle;
b) flowing the sample through the SEC column using a mobile phase consisting essentially of a low-ionic strength buffer, sucrose, and arginine; and
c) detecting the lipid nanoparticle eluted from the column with a detector.

### Examples

### Example 1: Analysis of Mobile Phase Compositions on LNP Separation

The following example describes the separation of samples comprising lipid nanoparticles using the methods and mobile phases described herein.

The impact of the ionic strength of the buffer was first assessed. A sample comprising a lipid nanoparticle was injected onto a size-exclusion chromatography column connected to an ACQUITY Premier ultra-high performance liquid chromatography system (available from Waters Technologies Corporation, Milford MA). The SEC column was a 4.6×150 mm column packed with porous particles having an average particle size of 3 μm and an average pore size of 2000 Å. Sample was flowed at a rate of 0.1 mL/min.

1 μL of sample was injected onto the column using one of four mobile phase compositions: 10 mM potassium phosphate buffer (pH 7.2), 5 mM potassium phosphate buffer (pH 7.2), 1 mM potassium phosphate buffer (pH 7.2), or 0.6 mM potassium phosphate buffer (pH 7.2) and flowed through the column. Sample was detected using an ultraviolet detector measuring at 260 nm.

As shown in FIG. 1A, decreasing the total ionic strength of the buffer increased signal and overall detection of the LNP sample (comparing, for example, the dotted line of 0.6 mM potassium phosphate to the solid line of 10 mM potassium phosphate). FIG. 1B provides an enhanced view of the chromatogram provided in FIG. 1A.

Additions to the mobile phase can impact both recovery of compounds (such as LNPs) from a sample and the separation of compounds in a sample (such as monomeric or aggregate LNPs). The addition of arginine was found to improve separation of LNPs in a sample, including the separation of LNP aggregates present in the LNP sample, while the addition of sucrose or sucrose and a non-ionic surfactant improved recovery of the LNPs present in the sample.

1 μL of sample was injected onto the column using one of two mobile phase compositions: 0.6 mM potassium phosphate (pH 7.2) with 0.006% polysorbate-80 or 0.6 mM potassium phosphate (pH 7.2) with 0.006% polysorbate-80 and 3 mM arginine, and flowed through the column. Sample was detected using an ultraviolet detector measuring at 260 nm.

As shown in FIG. 2A, the addition of 3 mM arginine increased the resolution of the LNP separation of LNP Sample #1, resolving as two peaks (dashed line) as compared to the single, wide peak obtained from the sample separated in the buffer without arginine (solid line). FIG. 2B provides an enhanced view of the chromatogram provided in FIG. 2A.

As shown in FIG. 2C, the addition of 3 mM arginine also increased the resolution of the LNP separation of LNP Sample #2, resolving a second peak (dashed line) as compared to the single peak obtained from the sample separated in the buffer without arginine (solid line). FIG. 2D provides an enhanced view of the chromatogram provided in FIG. 2C.

1 μL of sample was injected onto the column using a mobile phase buffer of 0.6 mM potassium phosphate (pH 7.2), 0.006% polysorbate 80, 3 mM arginine, and either 0 mM sucrose, 30 mM sucrose, or 50 mM sucrose. As shown in FIG. 3A-FIG. 3C, the addition of sucrose increases the overall recovery of the LNP sample (comparing the area under the curve for 0 mM sucrose to that of 50 mM sucrose).

1. A method for separating a sample comprising a lipid nanoparticle, the method comprising:
a) injecting onto a size-exclusion chromatography (SEC) column the sample comprising the lipid nanoparticle;
b) flowing the sample through the SEC column using a mobile phase comprising a low-ionic strength buffer, sucrose, and arginine; and
c) detecting the lipid nanoparticle eluted from the column with a detector.

2. The method of claim 1, wherein the low-ionic strength buffer comprises a salt selected from the group consisting of: potassium phosphate; monopotassium phosphate; dipotassium phosphate; sodium phosphate; monosodium phosphate; disodium phosphate; sodium chloride; potassium chloride; calcium chloride; magnesium chloride; potassium sulfate; sodium sulfate; and combinations thereof.

3. The method of claim 1, wherein the low-ionic strength buffer has a total ionic strength of between 0.1 to 30 mM.

4. The method of claim 3, wherein the low-ionic strength buffer has a total ionic strength of between 0.6 to 5 mM.

5. The method of claim 1, wherein the arginine is at a concentration of between 0.1 to 4 mM.

6. The method of claim 5, wherein the arginine is at a concentration of about 3 mM.

7. The method of claim 1, wherein the sucrose is at a concentration of between 20-200 mM.

8. The method of claim 1, wherein the mobile phase further comprises a non-ionic detergent.

9. The method of claim 8, wherein the non-ionic detergent is polysorbate 80 or polysorbate 20.

10. The method of claim 8, wherein the non-ionic detergent is at a concentration of between 0.006%-0.025% (w/v).

11. The method of claim 1, wherein the SEC column comprises hydroxy- or methoxy-terminated porous particles having a particle size of between 1 μm to 10 μm.

12. The method of claim 11, wherein the particle size is about 3 μm.

13. The method of claim 11, wherein the porous particles have an average pore diameter of between 1000 Å to 5000 Å.

14. The method of claim 13, wherein the average pore diameter is about 2000 Å.

15. The method of claim 1, wherein the detector is an ultraviolet detector.

16. The method of claim 15, wherein the ultraviolet detector measures at between 210 to 300 nm.

17. The method of claim 16, wherein the ultraviolet detector measures at between 260 nm to 280 nm.

18. The method of claim 1, wherein the detector is a multi-angle light scattering (MALS) detector.

19. The method of claim 1, wherein an interior surface of the SEC column comprises an alkylsilyl coating.

20. The method of claim 19, wherein the alkylsilyl coating comprises a vapor deposited product of bis(trichlorosilyl)ethane or bis(trimethoxysilyl)ethane.
